(19) United States
(12) Patent Application Publication
(10) Pub. No.: US 2022/0089863 A1
(43) Pub. Date: Mar. 24, 2022

(54) PRE-FORMS FOR MAKING BIODEGRADABLE CONTAINERS AND RESIN THEREFOR

(71) Applicant: Meredian Bioplastics, Inc., Bainbridge, GA (US)

(72) Inventors: Karson Durie, Athens, GA (US); Michael Mang, Bainbridge, GA (US)

(73) Assignee: Meredian Bioplastics, Inc., Bainbridge, GA (US)

(21) Appl. No.: 17/482,867

(22) Filed: Sep. 23, 2021

Related U.S. Application Data
(60) Provisional application No. 63/082,570, filed on Sep. 24, 2020.

(51) Int. Cl. C08L 67/04

(52) U.S. Cl. CPC C08L 67/04; C08L 2205/02; B29B 11/08; C08L 2203/10; C08L 2205/24; C08L 2201/06

(57) ABSTRACT

A preform for a biodegradable container wherein the preform includes from about 40 to about 99 weight percent of a polymer derived from random monomeric repeating units having a structure of

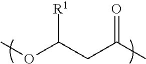

wherein R¹ is selected from the group consisting of CH₃ and a C₃ to C₁₉ alkyl group, wherein the polymer comprises from about 20 to about 99 wt. % of the preform and wherein the monomeric units wherein R¹═CH₃ comprise 75 to 99 mol percent of the polymer and wherein the preform has a body having a uniform wall thickness throughout the body of the preform. A resin adapted for forming the preform is also disclosed.

### TECHNICAL FIELD

The disclosure is directed to biodegradable containers and in particular compositions and methods for making preforms for biodegradable containers.

### BACKGROUND AND SUMMARY

With the current plastics crisis, plastics are being continuously replaced with bio-friendly alternatives. One large contributor to the plastic problem is poly(ethylene terephthalate) (PET) water bottles. It is estimated that in 2017 one million PET water bottles were sold every minute. Considering that it takes ˜450 years for a PET bottle to completely degrade, the earth is becoming over-polluted with PET bottles. Furthermore, while PET can be recycled, some developed countries, such as the US, only recycle a fraction of the PET bottles used, and other less-developed countries do not have a recycling system at all. In these countries with no recycling infrastructure, the PET bottles often end up in the ocean, breaking down into microplastics that begin to damage the ecosystem as the marine life consume them, mistaking them for food.

While other biopolymers are available as alternatives to PET, very few are viable for a replacement, being hard to mold, such as poly(butylene succinate) or if able to be molded into bottles, having dismal barrier properties, such as bottles made from poly(lactic acid). Additionally, few biopolymers are able to degrade in an acceptable amount of time or without the use of high temperatures/pressures. Poly(hydroxyalkanoate), referred to herein as “PHA,” is an excellent alternative for PET, as it degrades quickly without the need for external measures and can be formulated to be molded.

Currently, PET bottles are made through reheat injection stretch blow molding of preforms. PET bottle molding can be conducted in either a one-step or a two-step process. In a one-step process, preforms are injection molded into a preform mold with the desired neck finish and preform geometry. Then, on the same equipment, the preforms are conditioned through heaters and blown into a bottle mold using air and a stretch rod. The two-step process is similar, but the preforms are injected on a separate injection press. After injection, the preforms are reheated and blown into a bottle mold with a stretch rod and air. Currently, most bottles are made using a two-step process, as the preforms can be made, transported, and stored prior to blowing, thereby maximizing production.

During the blow molding process, preforms for bottles and containers made from poly(ethylene terephthalate) (PET) are heated above the glass transition temperature (T_{g}), wherein there is little deformation of the preform from the original form. Additionally, PET will self-regulate upon reheating and blow molding, and as a result, PET-based preforms will typically have different thicknesses along the preform to help move and distribute the material to the necessary parts of the bottle mold.

PHA-based materials, however, have a T_{g} below room temperature and have vastly different properties when compared to PET. As a result, for the PHA preforms to be pliable, the preforms must be heated near the melting temperature of PHA, which causes the PHA material to begin to flow and deform from the original design of the preform. In a typical reheat stretch blow molding setup, with a preform design typically used in PET blow molding, a PHA preform will shrink down to nearly half its size once reheated to a temperature needed for pliability. Additionally, there is no self-regulation in PHA-based materials as there is with PET materials, so once the material becomes pliable, the PHA material will flow irregularly, giving discrepancies in material distribution in the preform and in the final container. The irregular flow of the PHA preform is a problem as the preform will have thinner areas that are more prone to blow-outs or the container made from the PHA preforms will have thickness discrepancies throughout the container. Finally, when reheating a PHA-based preform material, the PHA material absorbs a significant amount of the irradiation, with thicker areas requiring more heat to become pliable than thinner areas. With a PHA-based material molded into a PET-based preform, the different thicknesses along the length of the preform result in a temperature differential, which can cause the material to be more prone to blow-outs during the molding process. Accordingly, what is needed is a preform for PHA-based materials that will mitigate the foregoing issues with molding PHA-based materials into containers.

In view of the foregoing, PHA preforms for containers are provided that improve the moldability of the PHA materials. In some embodiments, the disclosure provides a preform for a biodegradable container wherein the preform includes from about 40 to about 99 weight percent of a polymer derived from random monomeric repeating units having a structure of

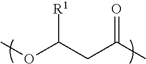

wherein R¹ is selected from the group consisting of CH₃ and a C₃ to C₁₉ alkyl group, wherein the polymer comprises from about 20 to about 99 wt. % of the preform and wherein the monomeric units wherein R¹═CH₃ comprise 75 to 99 mol percent of the polymer and wherein the preform has a body having a uniform wall thickness throughout the body of the preform.

The preform also typically includes from about 0.1 to about 10 weight percent of at least one nucleating agent and from about 0.005 to about 3 weight percent of at least one melt strength enhancer.

In some embodiments, the preform includes from about 40 to about 99 weight percent of poly(hydroxyalkanoate) copolymer and from about 1 to about 60 wt. % additional additives.

In other embodiments, the poly(hydroxyalkanoate) copolymer includes poly-3-hydroxybutyrate-co-3-hydroxyhexanoate (P3HB-co-P3HHx).

In some embodiments, the uniform wall thickness of the preform is selected from a thickness ranging from about 1.5 mm to about 5 mm.

In some embodiments, the preform has a length ranging from about 75 mm to about 120 mm.

In some embodiments, the preform, after being reheated, has a final mass to height ratio ranging from about 0.4 to about 0.5 grams/mm.

In some embodiments, the preform has a finish selected from PCO 1810, PCO 1881, 30/25, 29/25, 26 mm finishes, and the like.

In certain embodiments, the preform includes from about 0.1 weight percent to about 10 weight percent of at least one nucleating agent selected from erythritols, pentaerythritols, dipentaerythritols, artificial sweeteners, stearates, sorbitols, mannitols, inositols, polyester waxes, nanoclays, polyhydroxybutyrate, boron nitride, and mixtures thereof.

In some embodiments, the biodegradable container and the preform further include from about 0.05 weight percent to about 3 weight percent at least one melt strength enhancer chosen from the group consisting of a multifunctional epoxide; an epoxy-functional, styrene-acrylic polymer; an organic peroxide; an oxazoline; a carbodiimide; and mixtures thereof. In some embodiments, the amount of the melt strength enhancer is from about 0.05 to about 1 weight percent.

In some embodiments, the preform includes from about 0.1 weight percent to about 5 weight percent of a reheat agent selected from carbon black, infrared absorbing pigments, and mixtures thereof.

In some embodiments, the preform includes from about 0.1 weight percent to about 20 weight percent of a filler selected from calcium carbonate, talc, starch, zinc oxide, neutral alumina, and mixtures thereof. In some embodiments, the amount of filler is more preferably from about 0.1 to about 10 weight percent.

In some embodiments, the preform includes up to about 15 weight percent of a plasticizer selected from sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

In some embodiments, the preform is made by an injection molding or compression molding process.

In some embodiments, there is provided a method for making a biodegradable container from the biodegradable preform having a body having a uniform wall thickness throughout the body of the preform. The method includes forming the container in a process selected from reheat injection stretch blow molding, injection blow molding, and injection stretch blow molding.

In some embodiments, the biodegradable preform is molded into a biodegradable container having a volume ranging from about 25 mL to about 40 L.

An advantage of using a PHA preform, as described herein, having a uniform wall thickness throughout is that the uniform wall thickness helps to keep the temperature consistent throughout the preform during heating and melting. Another advantage of the disclosed preforms is that the preforms are relatively short and have a relatively high mass to height ratio. The relatively short, relatively thick preform provides more consistent and repeatable results, deforming less after reheating. Additionally, the short, thick preforms give better regulation of material flow in the container mold during blowing, as there are less differences in material temperature throughout the preform, giving less areas that are prone to blow-outs throughout the material.

In another aspect, the disclosure also provides a resin which is adapted for forming the biodegradable preform described above. The resin is made up of poly(hydroxyalkanoate) and optionally other polymers, as well as other additives as described above with respect to the preform.

### BRIEF DESCRIPTION OF THE DRAWINGS

FIGS. 1-3 are cross-sectional views, not to scale, of three preform designs made from PHA materials according to the disclosure.

FIG. 4 is an illustration of first, second and third preforms of different size made from a predetermined amount of PHA material.

FIG. 5 is an illustration of the first preform before reheating and examples of the first preform after reheating.

FIG. 6 are illustrations of free-blown articles made from the first preforms of FIG.

FIG. 7 is a graphical representation of temperature profiles for reheating the first preforms of FIG. 5.

FIG. 8 is an illustration of the second preform before reheating and examples of the second preform after reheating.

FIG. 9 are illustrations of free-blown articles made from the second preforms of FIG. 8.

FIG. 10 is a graphical representation of temperature profiles for reheating the second preforms of FIG. 8.

FIG. 11 is an illustration of the third preform before reheating and examples of the third preform after reheating.

FIG. 12 are illustrations of free-blown articles made from the third preforms of FIG. 11.

FIG. 13 is a graphical representation of temperature profiles for reheating the third preforms of FIG. 11.

FIG. 14 is an illustration showing size comparisons between the first, second and third preforms before and after reheating.

FIG. 15 is a side-by-side illustration of the first, second and third preforms after reheating.

### DETAILED DESCRIPTION

The present invention answers the need for preforms made from biodegradable materials that are capable of being easily processed into plastic containers. The biodegradable materials and containers made therefrom answer a need for disposable containers having increased biodegradability and/or compostability.

As used herein, “ASTM” means American Society for Testing and Materials.

As used herein, “alkyl” means a saturated carbon-containing chain which may be straight or branched; and substituted (mono- or poly-) or unsubstituted.

As used herein, “alkenyl” means a carbon-containing chain which may be monounsaturated (i.e., one double bond in the chain) or polyunsaturated (i.e., two or more double bonds in the chain); straight or branched; and substituted (mono- or poly-) or unsubstituted.

As used herein, “PHA” means a poly(hydroxyalkanoate) as described herein having random monomeric repeating units of the formula

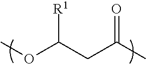

wherein R¹ is selected from the group consisting of CH₃ and a C₃ to C₁₉ alkyl group. The monomeric units wherein R¹ is CH₃ is about 75 to about 99 mol percent of the polymer.

As used herein, “P3HB” means the poly-(3-hydroxybutyrate).

As used herein, “P3HHx” means the poly(3-hydroxyhexanoate)

As used herein, “biodegradable” means the ability of a compound to ultimately be degraded completely into CO₂ and water or biomass by microorganisms and/or natural environmental factors, according to ASTM D5511 (anaerobic and aerobic environments), ASTM 5988 (soil environments), ASTM D5271 (freshwater environments), or ASTM D6691 (marine environments). Biodegradability can also be determined using ASTM D6868 and European EN 13432.

As used herein, “compostable” means a material that meets the following three requirements: (1) the material is capable of being processed in a composting facility for solid waste; (2) if so processed, the material will end up in the final compost; and (3) if the compost is used in the soil, the material will ultimately biodegrade in the soil according to ASTM D6400 for industrial and home compostability.

As used herein, “glass transition temperature” or “T_{g}” is the point at which amorphous regions of a polymer are converted from a brittle, glasslike state to a rubbery, flexible form.

All copolymer composition ratios recited herein refer to mole ratios, unless specifically indicated otherwise.

Unless otherwise noted, all molecular weights referenced herein are weight average molecular weights, as determined in accordance with ASTM D5296.

For the purposes of this disclosure, the preforms described herein are made from poly(hydroxyalkanoate) materials wherein at least about 50 mol %, but less than 100%, of the monomeric repeating units have CH₃ as R¹, more preferably at least about 60 mol %; more preferably at least about 70 mol %; more preferably at least about 75 to 98 mol %. In some embodiments, a minor portion of the monomeric repeating units have R¹ selected from alkyl groups containing from 3 to 19 carbon atoms. Accordingly, the copolymer may contain from about 0 to about 30 mol %, preferably from about 1 to about 25 mol %, and more particularly from about 2 to about 10 mol % of monomeric repeating units containing a C₃ to C₁₉ alkyl group as R¹.

In some embodiments, a preferred PHA copolymer for use with the present disclosure is poly-3-hydroxybutyrate-co-3-hydroxyhexanoate (P3HB-co-P3HHx). In certain embodiments, this PHA copolymer preferably comprises from about 94 to about 98 mole percent repeat units of 3-hydroxybutyrate and from about 2 to about 6 mole percent repeat units of 3-hydroxyhexanoate.

### Synthesis of Biodegradable PHAs

Biological synthesis of the biodegradable PHA materials used to make the preforms described herein may be carried out by fermentation with the proper organism (natural or genetically engineered) with the proper feedstock (single or multicomponent). Biological synthesis may also be carried out with bacterial species genetically engineered to express the copolymers of interest (see U.S. Pat. No. 5,650,555, incorporated herein by reference).

### Melt Temperature

Preferably, the biodegradable PHAs of the present invention have a melt temperature (Tₘ) of from about 30° C. to about 170° C., more preferably from about 90° C. to about 165° C., more preferably still from about 130° C. to about 160° C.

### Molded Articles

According to the disclosure, a polymeric container is formed from a resin comprising a polymer or copolymer materials (e.g., PHA) which are injected, compressed, or blown by means of a gas into shape defined by a female mold. In particular the molded articles may be plastic bottles that hold carbonated and non-carbonated liquids, as well as dry materials including, but not limited to powders, pellets, capsules, and the like.

Injection molding of thermoplastics is a multi-step process by which a PHA resin material is heated until it is molten, then forced into a closed mold where it is shaped, and finally solidified by cooling. The resulting PHA preform resembles a tube with open and closed ends, wherein the open end may be threaded.

Reheat injection stretch blow molding is typically used for producing bottles and other hollow objects (see EPSE-3). In this process, a PHA preform is heated and then placed into a closed, hollow mold. The preform is then expanded by air and a stretch rod, forcing the PHA against the walls of the mold. Subsequent cooling air then solidifies the molded article in the mold. The mold is then opened and the article is removed from the mold.

Blow molding is preferred over injection molding for containers, as it is easier to make extremely thin walls in a blow molding process. Thin walls mean less PHA in the final product, and production cycle times are often shorter, resulting in lower costs through material conservation and higher throughput. Extrusion blow molding may also be used to produce thin-walled containers.

### PHA Preforms

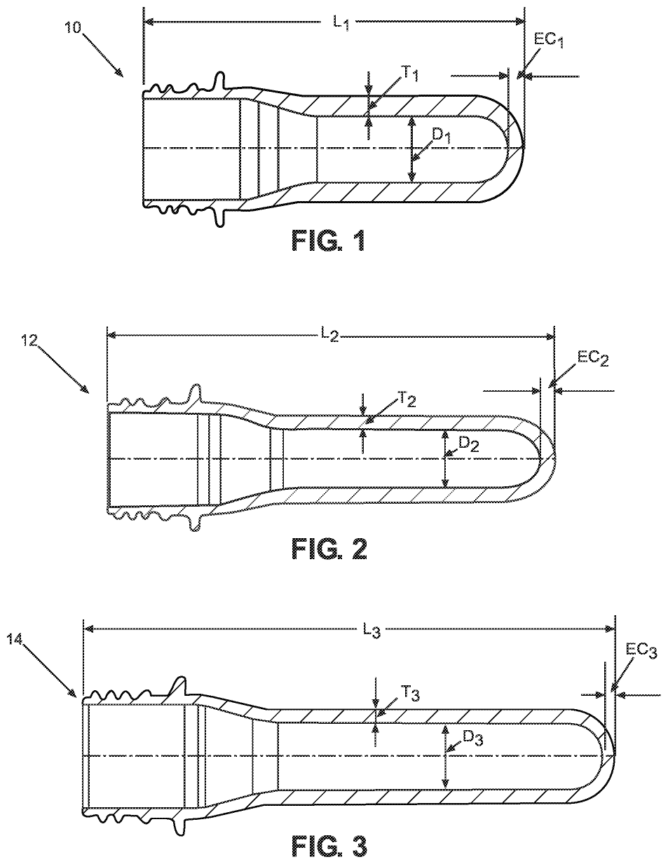

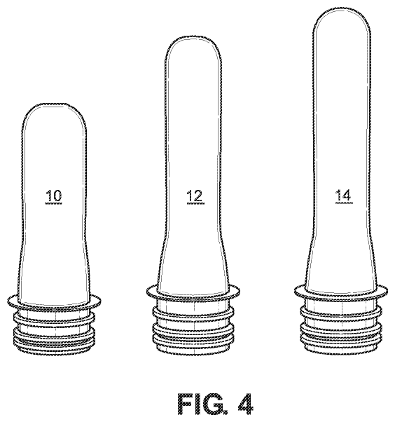

The design and structure of the PHA preform has a significant effect on the reheat behavior of the preform, the temperature profile of the preform and the blowability of the preform upon reheating. In order to determine how the thickness and length of the preform affects the performance of the preform, three preforms 10, 12, and 14 of different lengths as shown in FIGS. 1-4 were made from 20 grams of PHA material. Preform 10 had an overall length L₁ of 81 mm, a uniform wall thickness T₁ of 4.14 mm (excluding the threaded end), an inside diameter D₁ of 14 mm, and an end cap thickness EC₁ of 3.1 mm. Preform 12 had an overall length L₂ of 101 mm, a uniform wall thickness T₂ of 3.07 mm (excluding the threaded end), an inside diameter D₂ of 13.1 mm, and an end cap thickness EC₂ of 2.5 mm. Preform 14 had an overall length L₃ of 111 mm, a uniform wall thickness T₃ of 2.72 mm (excluding the threaded end), an inside diameter D₃ 13.7 mm, and an end cap thickness EC₃ of 2.2 mm. The preforms were heated in an oven having 10 heating zones until the preforms were sufficiently pliable to blow the preforms. Different oven temperature settings were used for each preform because of the different wall thicknesses of the preforms 10, 12, and 14. The oven settings were tuned for each preform in order to find the best oven temperatures that provided repeatable free-blow results. The oven temperature settings (displayed as the % power of the lamp in each heating zone) used are given in the following table.

TABLE 1

| Temperature Zone | Preform 10 | Preform 12 | Preform 14 |
|---|---|---|---|
| Zone 1 | 90 | 85 | 75 |
| Zone 2 | 40 | 35 | 30 |
| Zone 3 | 50 | 50 | 50 |
| Zone 4 | 80 | 80 | 80 |
| Zone 5 | 100 | 100 | 100 |
| Zone 6 | 100 | 100 | 100 |
| Zone 7 | 0 | 0 | 100 |
| Zone 8 | 0 | 0 | 0 |
| Zone 9 | 0 | 0 | 0 |
| Zone 10 | 0 | 0 | 0 |
| Overall | 95 | 77 | 68 |

As shown by the following figures, oven settings that provided enough heat to induce pliability sufficient for free blow preforms resulted in deformation of the preforms. The thinner, longer preforms 12 and 14 required less heat as evidenced by the overall oven settings. The preform 14 also required zone 7 to be used in order to adequately heat the end cap due to the length of the preform.

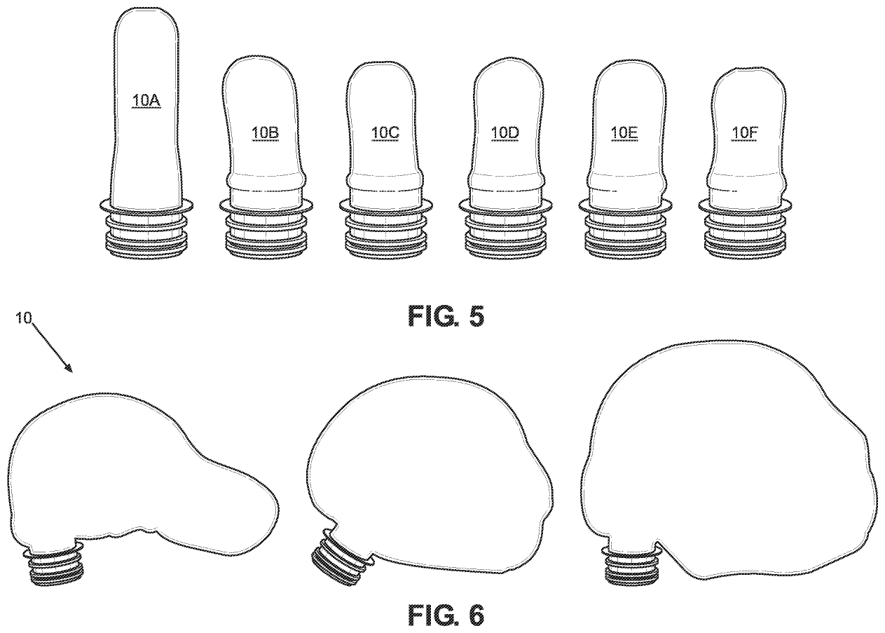

FIG. 5 illustrates repeat examples of the preform 10A before reheating, and the deformation of the preform 10A after reheating 10B-10F. Preform 10 experienced minimal shrinking upon reheating, but was still able to be blown into large free-blown articles as illustrated in FIG. 6. The deformation of preform 10 was small and did not result in the preform falling to one side in the oven.

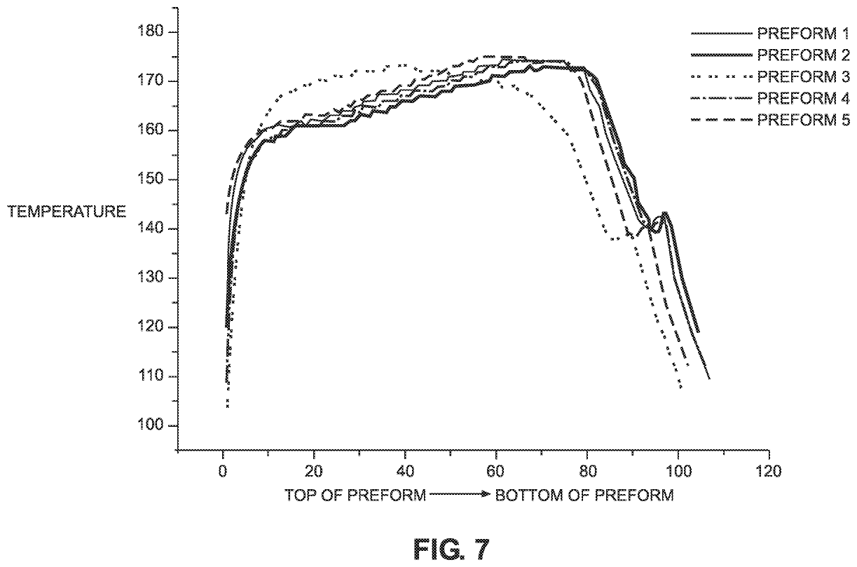

The following Table 2 and FIG. 7 show the temperature profile for different zones of several preforms 10, with zone 1 being the top of the preform. The inside temperature of the preforms was measured with a digital programmable thermal sensor and the outside temperature of the preforms was measured with a forward-looking infrared radar camera (FLIR). It was observed that the inside of the preforms was colder than the outside and that the temperature differential between the inside and the outside of was about 10° C. and increased consistently throughout the length of the preform 10. The inside temperature in degrees C. of preforms 10 for different zones along the length of the preforms is given in the following table.

TABLE 2

| Preform 10 | Zone 1 | Zone 2 | Zone 3 | Zone 4 |
|---|---|---|---|---|
| 10B | 151 | 154 | 159 | 97 |
| 10C | 158 | 158 | 158 | 98 |
| 10D | 149 | 161 | 160 | 99 |
| 10E | 157 | 152 | 157 | 97 |
| 10F | 157 | 157 | 157 | 97 |
| Average | 154.4 | 156.4 | 158.2 | 97.6 |

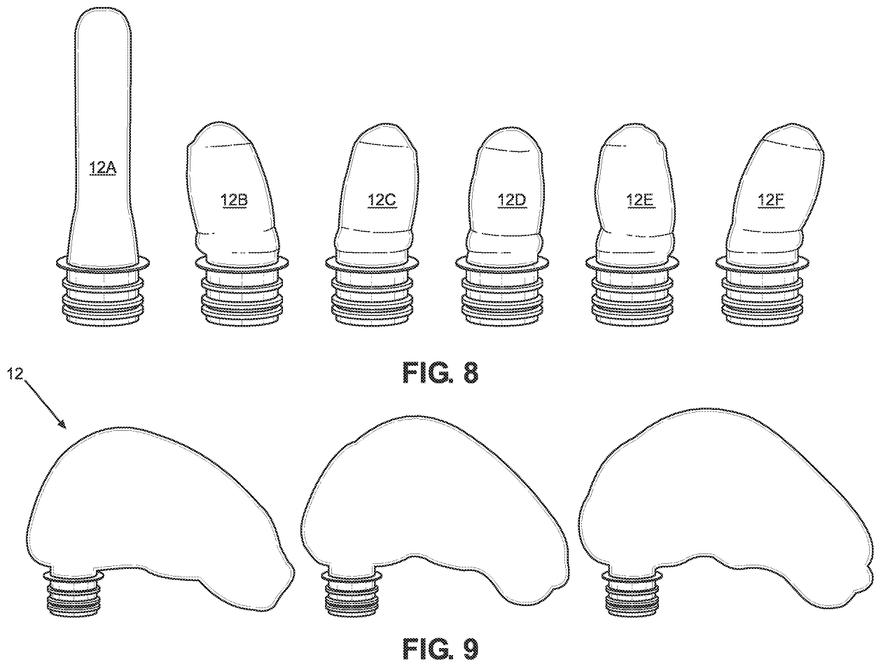

As seen in the foregoing table, the temperature inside the preform was consistent throughout the length of the preform, which gives consistent pliability and helps avoid areas prone to blow-outs. FIG. 8 illustrates repeat examples of the preform 12A before reheating, and the deformation of the preform 12A after reheating 12B-12F. Preform 12 experienced significant shrinking upon reheating, but was still able to be blown into free-blown articles (FIG. 9) that were smaller than the free-blown articles of FIG. 6. The deformation of preform 12 was greater than that of preform 10 but did not result in the preform falling to one side in the oven.

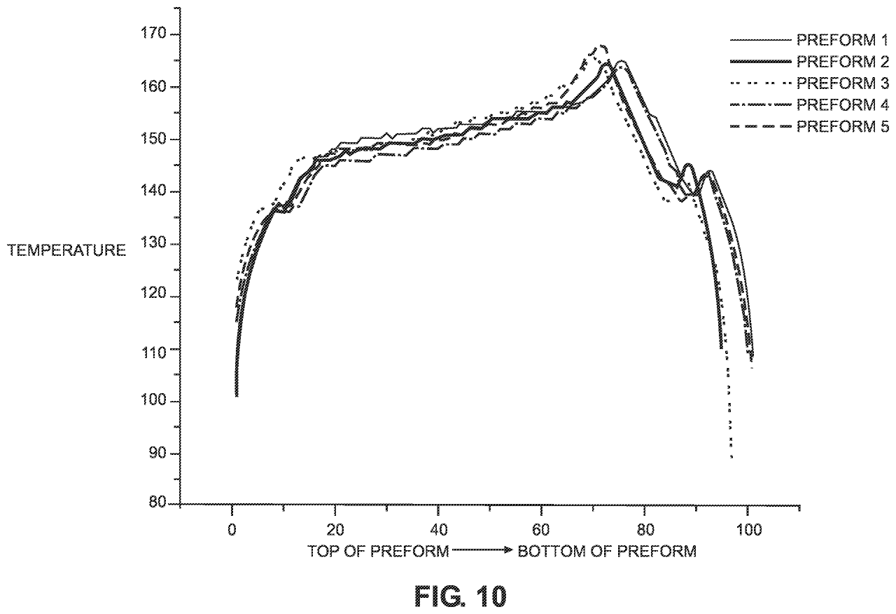

The following Table 3 and FIG. 10 show the temperature profile for different zones of several preforms 12, with zone 1 being the top of the preform. The inside temperatures of the preforms were colder toward to the top of the preforms and hotter toward the bottom of the preforms. There was a temperature differential throughout the length of the preforms, which resulted in areas prone to blowouts. Weak areas in the preform prevent successful free-blowing of large articles (like in FIG. 6) or blow molding containers from the preforms. The difference between the inside temperature and the outside temperature of the preforms changed depending on the location along the length of the preforms. The inside temperature in degrees C. of preforms 12 for different zones along the length of the preforms is given in the following table.

TABLE 3

| Preform 12 | Zone 1 | Zone 2 | Zone 3 | Zone 4 |
|---|---|---|---|---|
| 12B | 167 | 166 | 157 | 81 |
| 12C | 164 | 162 | 158 | 82 |
| 12D | 161 | 161 | 157 | 80 |
| 12E | 163 | 163 | 158 | 81 |
| 12F | 168 | 159 | 155 | 80 |
| Average | 164.6 | 162.2 | 157.0 | 80.8 |

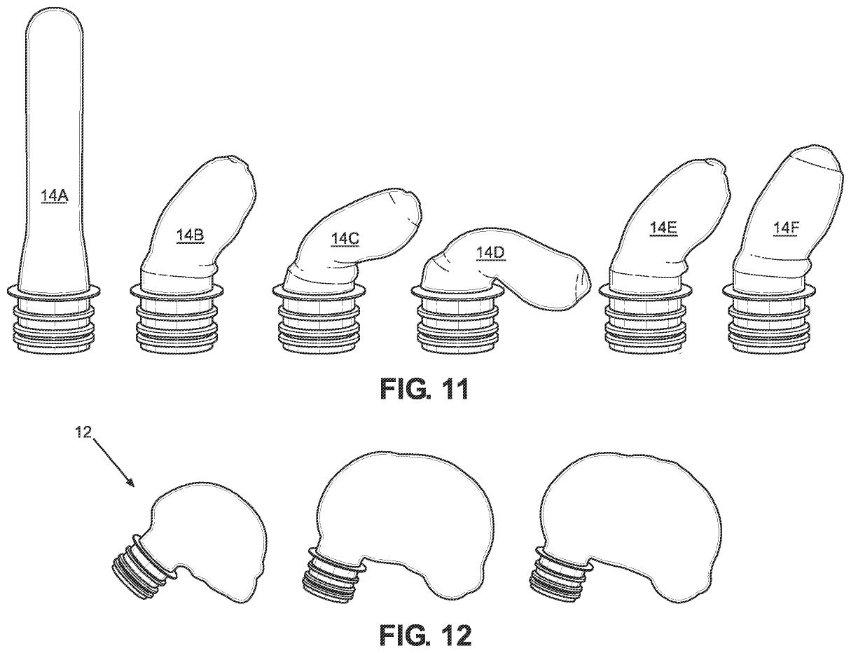

FIG. 11 illustrates repeat examples of the preform 14A before reheating, and the deformation of the preform 14A after reheating 14B-14F. Preform 14 experienced significant shrinking and deformation upon reheating. Free-blown articles made from the preforms 14 (FIG. 12) were smaller than the free-blown articles of FIG. 6 and FIG. 9. The preforms 14 repeatedly touched the oven or fell over during reheating. A lower oven temperature was attempted to be used, but resulted in the preform 14 being unable to be pliable.

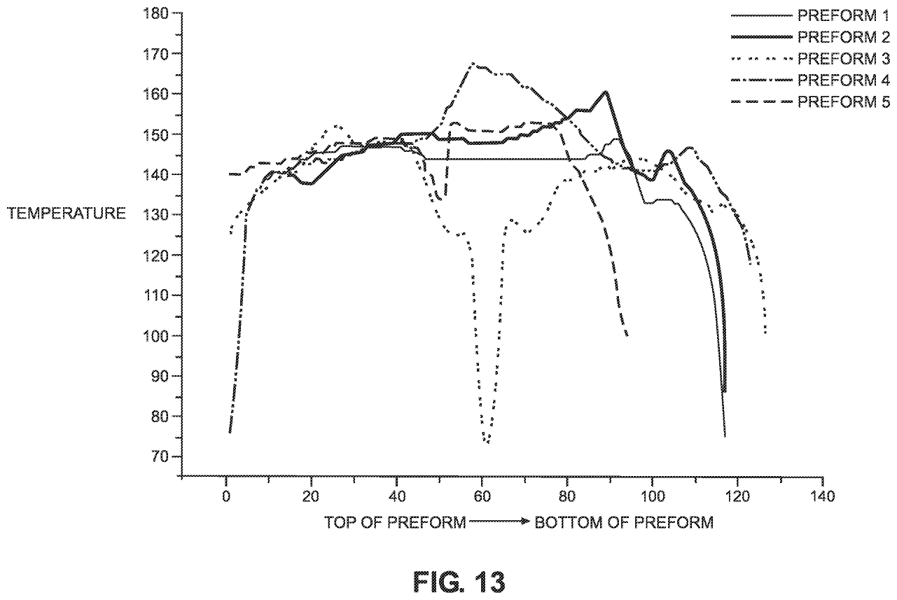

The following Table 4 and FIG. 13 show the temperature profile for different zones of several preforms 14, with zone 1 being the top of the preform. It was difficult to reliably measure the temperature profiles of the preforms 14 due to the preforms 14 falling over or leaning to one side during reheating. The inside temperature in degrees C. of preforms 14 for different zones along the length of the preforms is given in the following table.

TABLE 4

| Preform 14 | Zone 1 | Zone 2 | Zone 3 | Zone 4 |
|---|---|---|---|---|
| 14B | 163 | 155 | 144 | 77 |
| 14C | 167 | 151 | 151 | 81 |
| 14D | 155 | 142 | 143 | 78 |
| 14E | 152 | 162 | 1149 | 80 |
| 14F | 79 | 51 | 140 | 79 |
| Average | 159.3 | 152.5 | 146.8 | 79.0 |

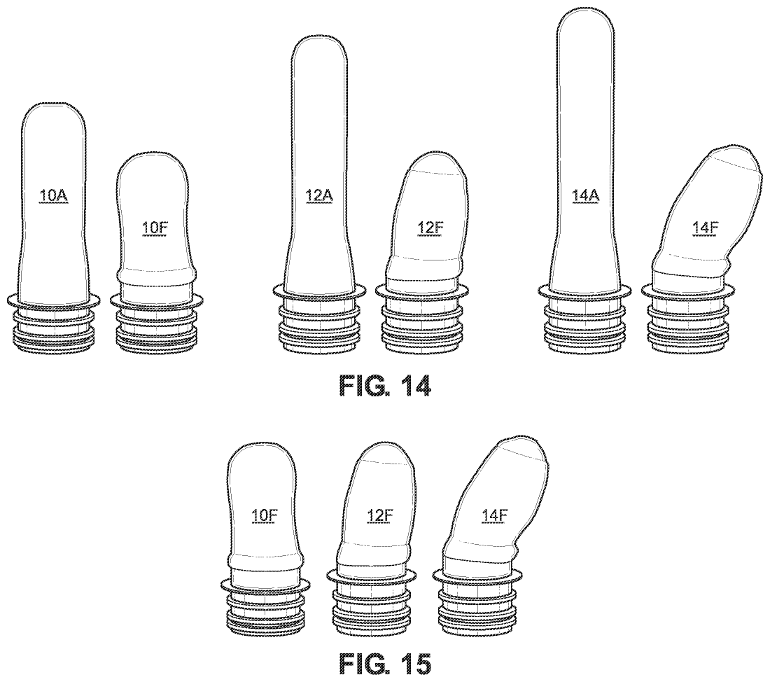

FIGS. 14 and 15 provide a comparison of each of the preforms 10, 12 and 14 before and after reheating. The bodies of preform 10 and preform 12 both shrunk to about 46 to 50 mm, while preform 14 was not able to be measured reliably due to the preform falling to one side or touching the oven.

Based on the foregoing examples, it was observed that the preform design is important for controlling deformation of the preform during reheating. The shortest preform 10 deformed less than the taller preforms 12 and 14, but was still pliable and had less deformation upon reheating. The longer preforms 12 and 14 had more issues with uniformity and repeatability during reheating. The shorter preform 10 with thicker walls made bigger free-blown articles and was less prone to blow outs during reheating compared to the taller preforms 12 and 14. Preform 10 also had more uniformity of material distribution during reheating than preforms 12 and 14. During reheating, preform 10 had a colder inside temperature but also a smaller temperature differential throughout the length of the preform than preforms 12 and 14. Preforms 12 and 14 had much greater temperature differentials throughout the length of the preforms during reheating.

### PHA Preform Formulations

PHA preforms made according to the disclosure are formed from a resin which may contain from about 40 to 99 weight percent of poly(hydroxyalkanoate) copolymer and from about 1 to about 60 wt. % polymer modifiers. In some embodiments, the poly(hydroxyalkanoate) copolymer is poly-3-hydroxybutyrate-co-3-hydroxyhexanoate (P3HB-co-P3HHx). In other embodiments, the PHA composition includes from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

In some embodiments, the PHA resin formulation may include from about 0.5 weight percent to about 15 weight percent of at least one plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, polyethylene glycols having a number average molecular weight of 400-10,000 g/mol, esters of vegetable oils, long chain alkyl acids, adipates, glycerol, isosorbide derivatives or mixtures thereof.

In other embodiments, the PHA resin formulation preferably also includes from about 0.1 weight percent to about 10 weight percent, or from about 0.1 to about 20 weight percent, of at least one nucleating agent selected from sulfur, erythritols, pentaerythritol, dipentaerythritols, inositols, stearates, sorbitols, mannitols, polyester waxes, compounds having a 2:1; 2:1 crystal structure chemicals, boron nitride, and mixtures thereof.

In some embodiments, the PHA resin formulation preferably includes from about 0 to about 1 percent by weight, such as from about 1 to about 0.5 percent by weight of a melt strength enhancer/rheology modifier. This melt strength enhancer may for instance be selected from the group consisting of a multifunctional epoxide; an epoxy-functional, styrene-acrylic polymer; an organic peroxide such as di-t-butyl peroxide; an oxazoline; a carbodiimide; and mixtures thereof.

Without being bound by theory, this additive is believed to act as a cross-linking agent to increase the melt strength of the PHA formulation. Alternatively, in some instances, the amount of the melt strength enhancer is from about 0.05 to about 3 weight percent. More preferred melt strength enhancers include organic peroxides, epoxides, and carbodiimides, preferably in an amount from about 0.05 to about 0.2 weight percent of the PHA formulation.

In some embodiments, the PHA resin formulation may include one or more performance enhancing polymers selected from poly(lactic acid), poly(caprolactone), poly(ethylene sebicate), poly(butylene succinate), and poly(butylene succinate-co-adipate), and copolymers and blends thereof. The performance enhancing polymers may be present in the formulation in a range of from about 1 to about 60 percent by weight. In some embodiments, from about 0.1 to about 15 weight percent of polylactic acid fibers are included in the polymer formulation for structural support of containers made from the polymer formulation.

In some embodiments, the polymer formulation includes from about 0.1 to about 5 weight percent of a reheat agent such as carbon black or another infrared absorbing material. In other embodiments, the polymer includes from about 0.1 to about 20 weight percent (preferably from about 0.1 to about 10 weight percent) of a filler selected from calcium carbonate, talc, starch, zinc oxide, neutral alumina, and mixtures thereof.

In some embodiments, the polymer formulation includes a slip agent. The most common slip agents are long-chain, fatty acid amides, such as erucamide and oleamide. One or more slip agents, for example calcium stearate or fatty acid amides is/are typically included in the polymer formulation. When included in the formulation, the amount of slip agent may range from about 0.1 to about 3 percent by weight of a total weight of the polymer formulation.

Exemplary formulations that may be used to make preforms for biodegradable containers according to the disclosure are shown in the following table.

TABLE 5

| | PHA | PHA | PHA | | | | | | |
|---|---|---|---|---|---|---|---|---|---|
| | polymer | polymer | polymer | | | | | | |
| | wt. % | wt. % | wt. % | | | | | | |
| | 3 mol % | 6 mol % | 9 mol % | Weight % | | Weight % | | | Weight % |
| | Hexanoate | Hexanoate | Hexanoate | Polylactic | Weight % | Organic | Weight % | Weight % | Polylactic |
| Formula | in polymer | in polymer | in polymer | acid | Pentaerythritol | peroxide | JONCRYL | Inositol | acid fibers |
| 1 | 59.34 | — | — | 39.56 | 1 | 0.1 | — | — | — |
| 2 | 69.23 | — | — | 29.67 | 1 | 0.1 | — | — | — |
| 3 | 79.12 | — | — | 19.78 | 1 | 0.1 | — | — | — |
| 4 | 99 | — | — | — | 1 | — | — | — | — |
| 5 | 94 | — | — | 5 | 1 | — | — | — | — |
| 6 | 98.9 | — | — | — | 1 | 0.1 | — | — | — |
| 7 | 65.87 | 32.93 | — | — | 1 | 0.2 | — | — | — |
| 8 | 98.8 | — | — | — | 1 | — | 0.2 | — | — |
| 9 | 24.7 | 74.1 | — | — | 1 | — | 0.2 | — | — |
| 10 | 49.4 | 49.4 | — | — | 1 | — | 0.2 | — | — |
| 11 | 74.1 | 24.7 | — | — | 1 | — | 0.2 | — | — |
| 12 | 93.8 | — | — | — | 1 | — | 0.2 | — | 5 |
| 13 | 49.4 | — | 49.4 | — | 1 | — | 0.2 | — | — |
| 14 | 74.1 | — | 24.7 | — | 1 | — | 0.2 | — | — |
| 15 | 98.2 | — | — | — | 1 | — | 0.8 | — | — |
| 16 | 97.8 | — | — | — | — | — | 0.2 | 2 | — |

With the formulations provided, PHA containers made from the preform formulations should degrade rapidly, but the degradation kinetics will depend on the design of the container, with thicker walled materials taking longer to fully degrade. It is preferred that the containers undergo degradation according to TUV Austria Program OK 12, have a shelf-life of at least 24 months, and have a moisture vapor transmission rate of about 20 g/m²/day or less as determined under ASTM E96. The containers may have a volume ranging from about 25 mL to about 40 L or more.

The present disclosure is also further illustrated by the following embodiments:

Embodiment 1. A preform for a biodegradable container wherein the preform comprises: from about 0.1 to about 10 weight percent of at least one nucleating agent; from about 0.05 to about 3 weight percent of at least one melt strength enhancer; and from about 40 to about 99 weight percent of a polymer derived from random monomeric repeating units having a structure of

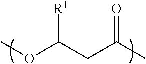

wherein R¹ is selected from the group consisting of CH₃ and a C₃ to C₁₉ alkyl group, wherein the monomeric units wherein R¹═CH₃ comprise 75 to 99 mol percent of the polymer and wherein the preform has a body having a uniform wall thickness throughout the body of the preform.

Embodiment 2. The preform of Embodiment 1, wherein the preform comprises from about 40 to about 99 weight percent of poly(hydroxyalkanoate) copolymer and from about 1 to about 60 wt. % additional additives.

Embodiment 3. The preform of Embodiment 2 wherein the poly(hydroxyalkanoate) copolymer comprises poly-3-hydroxybutyrate-co-3-hydroxyhexanoate (P3HB-co-P3HHx).

Embodiment 4. The preform of Embodiment 1, wherein the uniform wall thickness of the preform is selected from a thickness ranging from about 1.5 mm to about 5 mm.

Embodiment 5. The preform of Embodiment 1, wherein the preform has a length ranging from about 75 mm to about 120 mm.

Embodiment 6. The preform of Embodiment 1, wherein the preform, after being reheated has a final mass to height ratio ranging from about 0.4 to about 0.5 grams/mm.

Embodiment 7. The preform of Embodiment 1, wherein the preform has a finish selected from the group consisting of PCO 1810, PCO 1881, 30/25, 29/25, 26 mm finishes, and the like.

Embodiment 8. The preform of Embodiment 1, wherein the preform further comprises from about 1 weight percent to about 60 weight percent of polymers selected from the group consisting of poly(lactic acid), poly(caprolactone), poly(ethylene sebicate), poly(butylene succinate), and poly(butylene succinate-co-adipate), and copolymers and blends thereof.

Embodiment 9. The preform of Embodiment 1, wherein the preform further comprises from about 0.1 weight percent to about 5 weight percent of a reheat agent selected from the group consisting of carbon black, infrared absorbing pigments, and mixtures thereof.

Embodiment 10. The preform of Embodiment 1, wherein the preform further comprises from about 0.1 weight percent to about 10 weight percent of a filler selected from the group consisting of calcium carbonate, talc, starch, zinc oxide, neutral alumina, and mixtures thereof.

Embodiment 11. The preform of Embodiment 1, wherein the preform further comprises up to about 15 weight percent of a plasticizer selected from the group consisting of sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

Embodiment 12. The preform of Embodiment 1, wherein the preform is made by an injection molding or compression molding process.

Embodiment 13. A method for making a biodegradable container from the biodegradable preform of Embodiment 1 comprising forming the container in a process selected from the group consisting of reheat injection stretch blow molding, injection blow molding, and injection stretch blow molding.

Embodiment 14. The method of Embodiment 13, wherein the biodegradable preform is molded into a biodegradable container having a volume ranging from about 25 mL to about 40 L.

Embodiment 15. The preform of Embodiment 1, wherein the preform comprises from about 0.1 weight percent to about 10 weight percent of at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

Embodiment 16. The preform of Embodiment 1, wherein the preform comprises comprises from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A resin adapted for forming a preform for a biodegradable container wherein the resin comprises
from about 0.1 to about 10 weight percent of at least one nucleating agent;
from about 0.05 to about 3 weight percent of at least one melt strength enhancer; and
from about 40 to about 99 weight percent of a polymer derived from random monomeric repeating units having a structure of 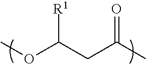
wherein R¹ is selected from the group consisting of CH₃ and a C₃ to C₁₉ alkyl group, wherein the monomeric units wherein R¹═CH₃ comprise 75 to 99 mol percent of the polymer and wherein the preform has a body having a uniform wall thickness throughout the body of the preform.

2. The resin of claim 1, wherein the resin comprises from about 40 to about 99 weight percent of poly(hydroxyalkanoate) copolymer and from about 1 to about 60 wt. % additional additives.

3. The resin of claim 2 wherein the poly(hydroxyalkanoate) copolymer comprises poly-3-hydroxybutyrate-co-3-hydroxyhexanoate (P3HB-co-P3HHx).

4. The resin of claim 1, wherein the uniform wall thickness of the preform is selected from a thickness ranging from about 1.5 mm to about 5 mm.

5. The resin of claim 1, wherein the preform has a length ranging from about 75 mm to about 120 mm.

6. The resin of claim 1, wherein the preform, after being reheated has a final mass to height ratio ranging from about 0.4 to about 0.5 grams/mm.

7. The resin of claim 1, wherein the preform has a finish selected from the group consisting of PCO 1810, PCO 1881, 30/25, 29/25, 26 mm finishes, and the like.

8. The resin of claim 1, wherein the resin further comprises from about 1 weight percent to about 60 weight percent of polymers selected from the group consisting of poly(lactic acid), poly(caprolactone), poly(ethylene sebicate), poly(butylene succinate), and poly(butylene succinate-co-adipate), and copolymers and blends thereof.

9. The resin of claim 1, wherein the resin further comprises from about 0.1 weight percent to about 5 weight percent of a reheat agent selected from the group consisting of carbon black, infrared absorbing pigments, and mixtures thereof.

10. The resin of claim 1, wherein the resin further comprises from about 0.1 weight percent to about 10 weight percent of a filler selected from the group consisting of calcium carbonate, talc, starch, zinc oxide, neutral alumina, and mixtures thereof.

11. The resin of claim 1, wherein the resin further comprises up to about 15 weight percent of a plasticizer selected from the group consisting of sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

12. The resin of claim 1, wherein the preform is made by an injection molding or compression molding process.

13. The resin of claim 1, wherein the resin comprises from about 0.1 weight percent to about 10 weight percent of at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

14. The resin of claim 1, wherein the resin comprises from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.
